(19) United States
(12) Patent Application Publication
(10) Pub. No.: US 2022/0128022 A1
(43) Pub. Date: Apr. 28, 2022

(54) DIESEL DUCTED FUEL INJECTOR

(71) Applicant: GM Global Technology Operations LLC, Detroit, MI (US)

(72) Inventors: Alberto Lorenzo Vassallo, Torino (IT); Francesco Concetto Pesce, Torino (IT); Riccardo Rossi, Torino (IT); Antonio Arpaia, Turin (IT); Simone Aletta, Turin (IT)

(21) Appl. No.: 17/079,865

(22) Filed: Oct. 26, 2020

(51) Int. Cl. F02M 55/00

(52) U.S. Cl. CPC F02M 55/008; F02M 2200/95

(57) ABSTRACT

An apparatus for a diesel engine in a motor vehicle includes a base and a plurality of ducts positioned on the base. The base is positioned about a fuel injector. When the fuel injector injects a plurality of fuel sprays into a cylinder of the diesel engine, some of the plurality of fuel sprays are directed by the plurality of ducts into the cylinder.

### INTRODUCTION

The present disclosure relates to fuel injectors for diesel engines in motor vehicles. More particularly, the present disclosure relates to ducted fuel injectors for diesel engines.

Many motor vehicles utilize a diesel engine as a power plant to operate the vehicle. Typically, the diesel engine is calibrated to produce low NOx during the combustion process, but this tends to increase soot production. To compensate for this soot production, some technologies such as injectors with piston bowls have been developed. These technologies, however, are quite complex and costly to implement into diesel engines.

Thus, while current fuel injection systems for diesel engines achieve their intended purpose, there is a need for a new and improved fuel injections system that provides for ultra-low NOx production and significant reduction of soot tendency.

### SUMMARY

According to several aspects, an apparatus for a diesel engine in a motor vehicle includes a base and a plurality of ducts positioned on the base. The base is positioned about a fuel injector. When the fuel injector injects a plurality of fuel sprays into a cylinder of the diesel engine, some of the plurality of fuel sprays are directed by the plurality of ducts into the cylinder.

In an additional aspect of the present disclosure, the base includes a projection that engages with a notch in the cylinder to ensure that the base and the plurality of ducts are properly oriented in the cylinder.

In another aspect of the present disclosure, a glow plug ignites a fuel spray to initiate a combustion process in the cylinder.

In another aspect of the present disclosure, one of the plurality of fuel sprays is not directed by any of the plurality of ducts.

In another aspect of the present disclosure, the fuel spray not directed by any of the plurality of ducts is a fuel spray located closest to a glow plug.

In another aspect of the present disclosure, the ignition of the fuel spray closest to the glow plug initiates a combustion process in the other fuel sprays of the plurality of fuel sprays.

In another aspect of the present disclosure, a duct angle of each of the plurality of ducts is less than about 5° with respect to a respective fuel spray.

In another aspect of the present disclosure, the base is configured to be press-fit into a head of the cylinder.

In another aspect of the present disclosure, an outer diameter of the base is between about 20 mm and 26 mm.

In another aspect of the present disclosure, an inner diameter of the base is between about 7 mm and 9 mm.

In another aspect of the present disclosure, an inlet of each duct is positioned between about 2 mm and 3 mm from a center of the fuel injector.

According to several aspects, a diesel engine for a motor vehicle includes a fuel injector with a plurality of outlets, each of the outlets injecting a fuel spray into a cylinder of the diesel engine, and a device including a base and a plurality of ducts positioned on the base, the base being positioned about the fuel injector. When the fuel injector injects the fuel sprays into the cylinder of the diesel engine, some of the fuel sprays are directed by the plurality of ducts into the cylinder.

In another aspect of the present disclosure, the base includes a projection that engages with a notch in the cylinder to ensure that the base and the plurality of ducts are properly oriented in the cylinder.

In another aspect of the present disclosure, a glow plug ignites a fuel spray to initiate a combustion process in the cylinder.

In another aspect of the present disclosure, one of the fuel sprays is not directed by any of the plurality of ducts.

In another aspect of the present disclosure, the fuel spray not directed by any of the plurality of ducts is a fuel spray located closest to a glow plug.

In another aspect of the present disclosure, the ignition of the fuel spray closest to the glow plug initiates a combustion process in the other fuel sprays.

According to several aspects, a diesel engine for a motor vehicle includes a fuel injector with a plurality of outlets, each of the outlets injecting a respective fuel spray into a cylinder of the diesel engine, a device including a base and a plurality of ducts positioned on the base, the base being positioned about the fuel injector, the base including a projection that engages with a notch in the cylinder to ensure that the base and the plurality of ducts are properly oriented in the cylinder, some of the fuel sprays being directed by the plurality of ducts into the cylinder, and a glow plug that ignites a fuel spray to initiate a combustion process in the cylinder.

In another aspect of the present disclosure, one of the fuel sprays is not directed by any of the plurality of ducts, the fuel spray not directed by any of the plurality of ducts being a fuel spray located closest to the glow plug.

In another aspect of the present disclosure, the ignition of the fuel spray closest to the glow plug initiates a combustion process in the other fuel sprays.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is an interior view of a cylinder head according to an exemplary embodiment;

FIG. 2A is a partial side view of a device for ducted fuel injection according to an exemplary embodiment;

FIG. 2B is a top view of the device for ducted fuel injection according to an exemplary embodiment;

FIG. 2C is a side view of the device for ducted fuel injection according to an exemplary embodiment; and

FIG. 3 is a perspective view of the device for ducted fuel injection according to an exemplary embodiment.

### DETAILED DESCRIPTION

The following description is merely exemplary in nature and is not intended to limit the present disclosure, application, or uses.

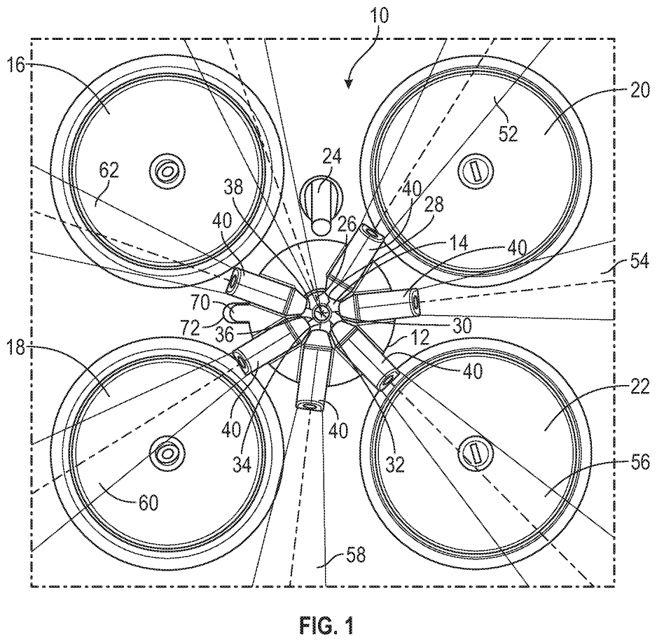

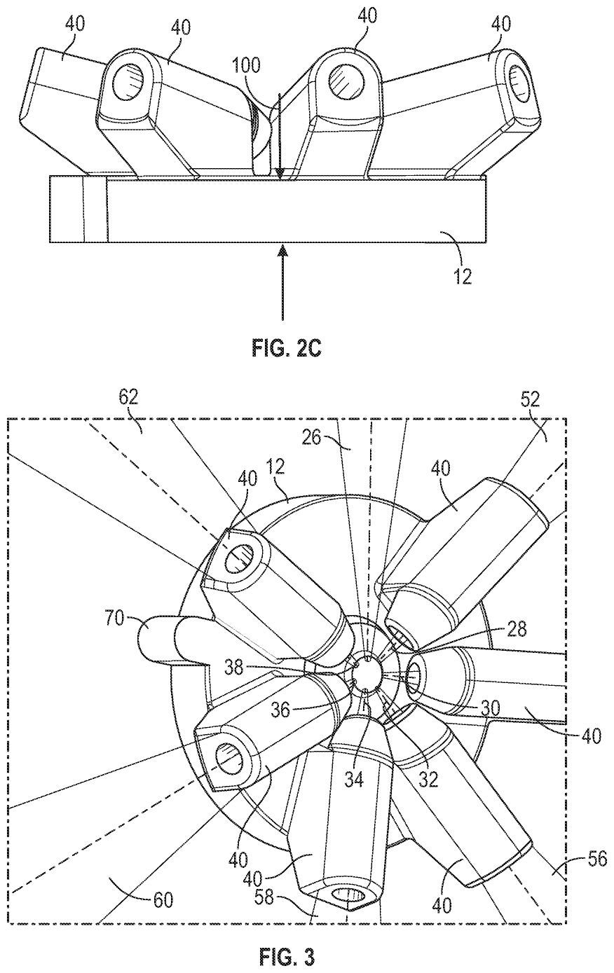

Referring to FIG. 1, there is shown a head of a cylinder of a diesel engine for a motor vehicle. The cylinder head includes a pair of intake valves 20, 22 through which air is brought into the cylinder head and a pair of exhaust valves 16 and 18 through which combustion products are removed from the cylinder. Referring also to FIG. 3, a device 10 is positioned about a fuel injector 14 that ejects fuel sprays 26, 28, 30, 32, 34, 36 and 38. The fuels sprays 28, 30, 32, 34, 36 and 38 are channeled by a set of ducts 40 positioned on a base 12 along with air introduced by the intake valves 20 and 22, while the fuel spray 26 is not channeled by a duct. The fuel sprays 28, 30, 32, 34, 36 and 38 are emitted from the ducts 40 as fuel sprays 52, 54, 56, 58, 60 and 62 entrained with air.

The ducts 40 enable the increase of fuel lean-out to significantly reduce sooting, similar to how a Bunsen burner operates, while producing low amounts of NOx. The device 10 is configured to be an add-on device in existing diesel combustion systems.

Of the fuel sprays 26, 28, 30, 32, 34, 36 and 38, the spray 26 is the most proximate to a glow plug 24. As such, when the glow plug is energized, the fuel spray 26 is ignited to initiate a combustion process, which in turn initiates a combustion process in the channeled fuel sprays 52, 54, 56, 58, 60 and 62.

The base 12 includes a projection or protrusion 70 that is configured to fit into a notch 72 of the cylinder head to ensure the proper orientation of the device 10 with respect to the sprays 26, 28, 30, 32, 34, 36 and 38, as well the glow plug 24. In various arrangements, one or more of the ducts 40 include side holes that are circular or extend longitudinally along the axis of the duct 40 to increase air entrainment into the ducts 40. FIGS. 1 and 3 shown a device 10 with six ducts 40. In various arrangements, the device 10 includes fewer than six ducts, while in other arrangements, the device 10 includes more than six ducts.

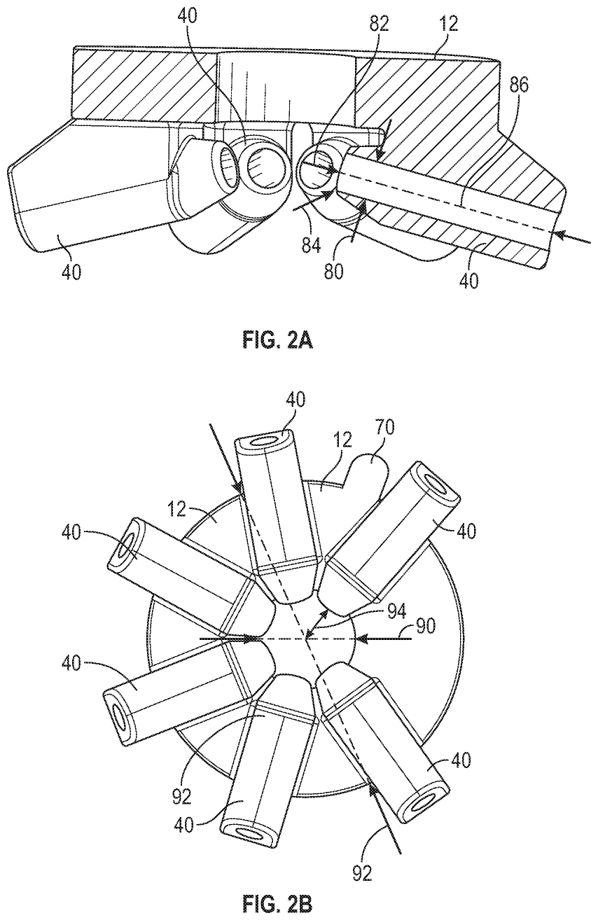

The installation of the device 10 requires a simple press-fit operation into existing cylinder heads. The specification of the device 10 is tuned for each engine application. For example, referring now to FIGS. 2A, 2B and 2C, there is shown a particular arrangement for the device 10. In this arrangement, each duct 40 has a hole diameter 80 between about 2 mm and 3 mm. The hole diameter is chosen to avoid fuel ignition in the duct 40 while providing desired fuel penetration and low coking. A hole length 82 is between about 12 mm and 14 mm. The hole length 82 is chosen to minimize the distance to the intake valves 20 and 22 while providing desired a lift-off length. The inlet rounding radius for each hole is between about 0.5 mm and 1 mm to improve the efficiency of the air introduced from the intake valves 20 and 22 into each duct 40. Further, the ducts 40 are configured with respect to the axis of each fuel spray such that the ducts and the fuel sprays 28, 30, 32, 34, 36 and 38 are coaxial. As such, the duct angle of the ducts 40 with respect to the fuel sprays 28, 30, 32, 34, 36 and 38 less than about 5°.

Additional features of this particular arrangement are associated with the base 12. For example, an inner diameter 90 of the base 12 is chosen to accommodate the fuel injector 14, which in this case is between about 7 mm and 9 mm. An outer diameter 92 is chosen to provide mechanical robustness of the device 10 when the base 12 is press-fit into the cylinder head while minimizing the distance (for example, 4 mm) to the valve seats. Accordingly, in some arrangements, the outer diameter 92 is between about 20 mm and 26 mm. In various arrangements, a distance 94 between the center of the fuel injector 14 and the entrance into each of the ducts 40 is chosen to provide appropriate air entrainment with the fuel sprays 28, 30, 32, 34, 36 and 38 into the respective ducts 40, while ensuring appropriate centering of the fuel spays into the ducts 40. In particular arrangements, the distance 94 is between about 2 mm and 3 mm. Finally, a thickness 100 of the base 12 is chosen to provide a desired mechanical robustness during the insertion of the device 10 into the cylinder head, while minimizing the distance to the water jackets and valve seats, for example 4 mm. In particular arrangements, the base thickness 100 is between about 4 mm and 6 mm.

A diesel ducted fuel injector of the present disclosure offers several advantages. These include: improved fuel air entrainment and increased lift-off lengths, which counters soot production; the device 10 is fully compatible with existing cylinder head geometries and can be inserted with the same technology as valve seats (for example, sintered power metal, adaptive manufacturing, 3D printing); servicing of the injector 14 does not impact the operation of the device 10 and vice versa; the device 10 utilizes principles of a Bunsen burner on a miniaturized scale so that the device 10 achieves results comparable to injection and bowl technologies.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An apparatus for a diesel engine in a motor vehicle, the apparatus comprising:
a base; and
a plurality of ducts positioned on the base,
wherein the base is positioned about a fuel injector, and
wherein when the fuel injector injects a plurality of fuel sprays into a cylinder of the diesel engine, some of the plurality of fuel sprays are directed by the plurality of ducts into the cylinder.

2. The apparatus of claim 1, wherein the base includes a projection that engages with a notch in the cylinder to ensure that the base and the plurality of ducts are properly oriented in the cylinder.

3. The apparatus of claim 1, wherein a glow plug ignites a fuel spray to initiate a combustion process in the cylinder.

4. The apparatus of claim 1, wherein one of the plurality of fuel sprays is not directed by any of the plurality of ducts.

5. The apparatus of claim 4, wherein the fuel spray not directed by any of the plurality of ducts is a fuel spray located closest to a glow plug.

6. The apparatus of claim 5, wherein the ignition of the fuel spray closest to the glow plug initiates a combustion process in the other fuel sprays of the plurality of fuel sprays.

7. The apparatus of claim 1, wherein a duct angle of each of the plurality of ducts is less than about 5° with respect to a respective fuel spray.

8. The apparatus of claim 1, wherein the base is configured to be press-fit into a head of the cylinder.

9. The apparatus of claim 8, wherein an outer diameter of the base is between about 20 mm and 26 mm.

10. The apparatus of claim 9, wherein an inner diameter of the base is between about 7 mm and 9 mm.

11. The apparatus of claim 1, wherein an inlet of each duct is positioned between about 2 mm and 3 mm from a center of the fuel injector.

12. A diesel engine for a motor vehicle comprising:
a fuel injector with a plurality of outlets, each of the outlets injecting a fuel spray into a cylinder of the diesel engine; and
a device including a base and a plurality of ducts positioned on the base, the base being positioned about the fuel injector,
wherein when the fuel injector injects the fuel sprays into the cylinder of the diesel engine, some of the fuel sprays are directed by the plurality of ducts into the cylinder.

13. The diesel engine of claim 12, wherein the base includes a projection that engages with a notch in the cylinder to ensure that the base and the plurality of ducts are properly oriented in the cylinder.

14. The diesel engine of claim 12, wherein a glow plug ignites a fuel spray to initiate a combustion process in the cylinder.

15. The diesel engine of claim 12, wherein one of the fuel sprays is not directed by any of the plurality of ducts.

16. The diesel engine of claim 15, wherein the fuel spray not directed by any of the plurality of ducts is a fuel spray located closest to a glow plug.

17. The diesel engine of claim 16, wherein the ignition of the fuel spray closest to the glow plug initiates a combustion process in the other fuel sprays.

18. A diesel engine for a motor vehicle comprising:
a fuel injector with a plurality of outlets, each of the outlets injecting a respective fuel spray into a cylinder of the diesel engine;
a device including a base and a plurality of ducts positioned on the base, the base being positioned about the fuel injector, the base including a projection that engages with a notch in the cylinder to ensure that the base and the plurality of ducts are properly oriented in the cylinder, some of the fuel sprays being directed by the plurality of ducts into the cylinder; and
a glow plug that ignites a fuel spray to initiate a combustion process in the cylinder.

19. The diesel engine of claim 18, wherein one of the fuel sprays is not directed by any of the plurality of ducts, the fuel spray not directed by any of the plurality of ducts being a fuel spray located closest to the glow plug.

20. The diesel engine of claim 19, wherein the ignition of the fuel spray closest to the glow plug initiates a combustion process in the other fuel sprays.
